(19) United States
(12) Patent Application Publication
(10) Pub. No.: US 2024/0396132 A1
(43) Pub. Date: Nov. 28, 2024

(54) BATTERY PACK

(71) Applicant: MURATA MANUFACTURING CO., LTD., Kyoto (JP)

(72) Inventors: Kazuhito HATTA, Kyoto (JP); Daiki MISAWA, Kyoto (JP)

(21) Appl. No.: 18/796,942

(22) Filed: Aug. 7, 2024

Related U.S. Application Data
(63) Continuation of application No. PCT/JP2023/010761, filed on Mar. 17, 2023.

(30) Foreign Application Priority Data
Mar. 29, 2022 (JP) 2022-054076

(51) Int. Cl. H01M 50/184; H01M 50/105; H01M 50/121; H01M 50/186; H01M 50/211; H01M 50/46

(52) U.S. Cl. CPC H01M 50/184; H01M 50/105; H01M 50/121; H01M 50/186; H01M 50/211; H01M 50/46

(57) ABSTRACT

A battery pack is provided and includes a secondary battery including a laminated body including a plurality of positive electrodes and a plurality of negative electrodes, the positive electrodes and the negative electrodes being alternately laminated with separators interposed therebetween, and an exterior body; and a housing that accommodates the secondary battery. The exterior body includes an accommodating portion that accommodates the laminated body, and a flange portion that is bendable around the accommodating portion. The housing has a first inner surface and a second inner surface facing the first inner surface with the accommodating portion interposed therebetween. The flange portion includes: a first portion extending along a first direction from the accommodating portion toward the first inner surface; and a second portion that is continuous from a distal end of the first portion and has a first fixing surface fixed to the first inner surface. In the flange portion, a portion along the first direction between the accommodating portion and the first fixing surface is bendable in a direction in which the accommodating portion approaches the first inner surface or in a direction in which the accommodating portion separates from the first inner surface.

### CROSS SECTION TO RELATED APPLICATIONS

The present application is a continuation of PCT/JP2023/010761, filed on Mar. 17, 2023, which claims priority to Japanese patent application no. 2022-054076, filed on Mar. 29, 2022, the entire contents of which are incorporated herein by reference.

### BACKGROUND

The present disclosure relates to a battery pack.

A battery unit is disclosed and including a battery laminated body in which a plurality of battery cells are laminated, and a housing that accommodates the battery laminated body. The battery laminated body is attached to the housing with a stand interposed therebetween.

### SUMMARY

The present disclosure relates to a battery pack.

When the battery unit vibrates in actual use, a lateral force is applied to the battery laminated body (laminated body). At this time, stress corresponding to the weight of the entire battery laminated body is applied to the fixed portion of one battery cell fixed to the frame. As a result, there arises a problem that an exterior body of a fixed portion of one battery cell fixed to the frame is damaged.

The present disclosure, in an embodiment, relates to suppress breakage of an exterior body in a battery pack including a secondary battery having the exterior body that accommodates a laminated body.

A battery pack of the present disclosure, in an embodiment, includes: a secondary battery including a laminated body including a plurality of positive electrodes and a plurality of negative electrodes, the positive electrodes and the negative electrodes being alternately laminated with separators interposed therebetween, and an exterior body; and a housing that accommodates the secondary battery, in which the exterior body includes an accommodating portion that accommodates the laminated body, and a flange portion that is bendable around the accommodating portion, in which the housing has a first inner surface and a second inner surface facing the first inner surface with the accommodating portion interposed therebetween, in which the flange portion includes: a first portion extending along a first direction from the accommodating portion toward the first inner surface; a second portion that is continuous from a distal end of the first portion and has a first fixing surface fixed to the first inner surface; a third portion extending along a second direction from the accommodating portion toward the second inner surface; and a fourth portion that is continuous from a distal end of the third portion and has a second fixing surface fixed to the second inner surface, and in which, in the flange portion, a portion along the first direction between the accommodating portion and the first fixing surface and a portion along the second direction between the accommodating portion and the second fixing surface are bendable in a direction in which the accommodating portion approaches the first inner surface or in a direction in which the accommodating portion separates from the first inner surface.

According to the battery pack of the present disclosure, in an embodiment, damage to the exterior body of the secondary battery can be prevented.

### BRIEF DESCRIPTION OF THE FIGURES

FIG. 1 is a perspective view of an external appearance of a battery pack according to an embodiment.

FIG. 2 is a longitudinal sectional view of the battery pack according to an embodiment.

FIG. 3 is a plan view of a secondary battery.

FIG. 4 is a side view of the secondary battery.

FIG. 5 is an exploded perspective view of the secondary battery.

FIG. 6 is a sectional view taken along line A-A of the secondary battery before a second portion is formed.

FIG. 7 is a sectional view taken along line A-A of the secondary battery.

FIG. 8 is a sectional view taken along line A-A of the secondary battery in the battery pack according to an embodiment.

FIG. 9 is a longitudinal sectional view of a battery pack according to a modification of an embodiment.

FIG. 10 is an exploded perspective view of a secondary battery according to another modification of an embodiment.

### DETAILED DESCRIPTION

The present disclosure will be described in further detail including with reference to the drawings. The present disclosure is not limited thereto. Each embodiment is illustrative, and thus replacement and combination of a part of configurations shown in the different embodiments can be performed. In a second and subsequent embodiments, matters common to those of a first embodiment will not be described, and only differences will be described. In particular, a similar effect by a similar structure will not be sequentially referred to for each embodiment.

The X direction, the Y direction, and the Z direction shown in the drawings correspond to the width direction, the depth direction, and the height direction of the secondary battery included in the battery pack, respectively. Note that the X, Y, and Z directions are examples, and the present disclosure is not limited to these directions.

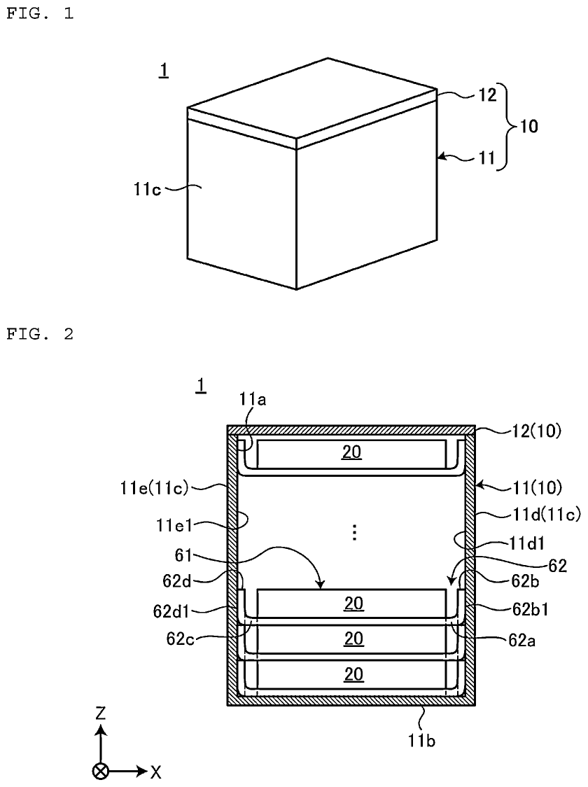

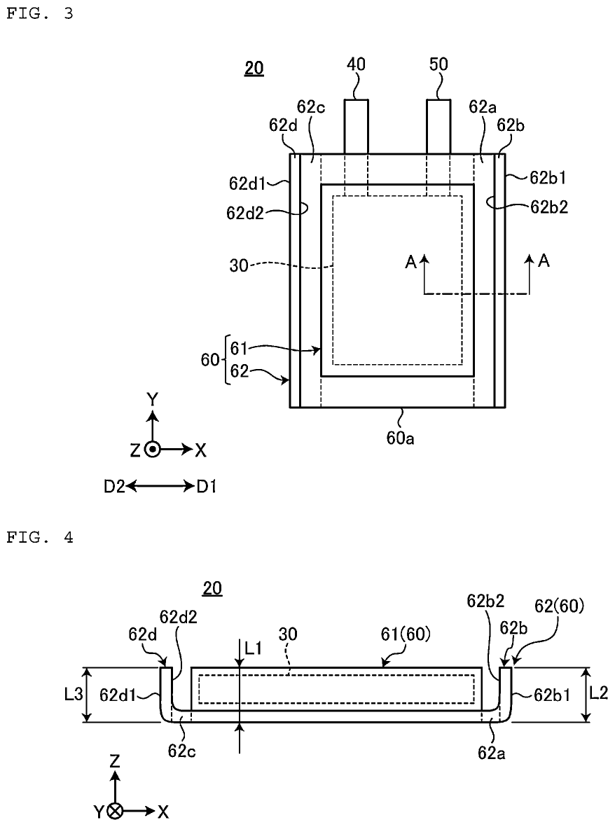

FIG. 1 is a perspective view of an external appearance of a battery pack according to an embodiment. FIG. 2 is a longitudinal sectional view of the battery pack according to an embodiment.

The battery pack 1 can be applied as a power source to an electric vehicle, a power tool, an electronic device, and the like. As shown in FIGS. 1 and 2, the battery pack 1 includes a housing 10 and a secondary battery 20. Although the battery pack 1 includes a connection terminal portion, a control circuit, and the like for connecting the secondary batteries 20 to each other, the connection terminal portion, the control circuit, and the like are not described herein.

The housing 10 includes a main body portion 11 and a lid portion 12. The main body portion 11 has a box shape having an opening 11a, and accommodates the plurality of secondary batteries 20. The main body portion 11 includes a bottom wall 11b and a side wall 11c at a peripheral edge of the bottom wall 11b. Specifically, the bottom wall 11b has a rectangular shape in plan view.

The side wall 11c includes a first wall plate lid and a second wall plate lie facing each other. A first inner surface 11d1 of the first wall plate lid and a second inner surface 11e1 of the second wall plate lie face each other and are parallel to each other. The lid portion 12 covers the opening 11a. The housing 10 includes an external connection terminal (not shown) electrically connected to an electric vehicle or the like.

The secondary battery 20 is, for example, a lithium ion battery. The battery pack 1 includes a plurality of secondary batteries 20. The plurality of secondary batteries 20 are laminated in a state where accommodating portions 61 described later overlap in the housing 10. The plurality of secondary batteries 20 are laminated along the Z direction of the secondary batteries 20. That is, the laminating direction of the plurality of secondary batteries 20 corresponds to the Z direction. In addition, the first inner surface 11d1 and the second inner surface 11e1 face each other with the accommodating portions 61 of the secondary batteries 20 interposed therebetween.

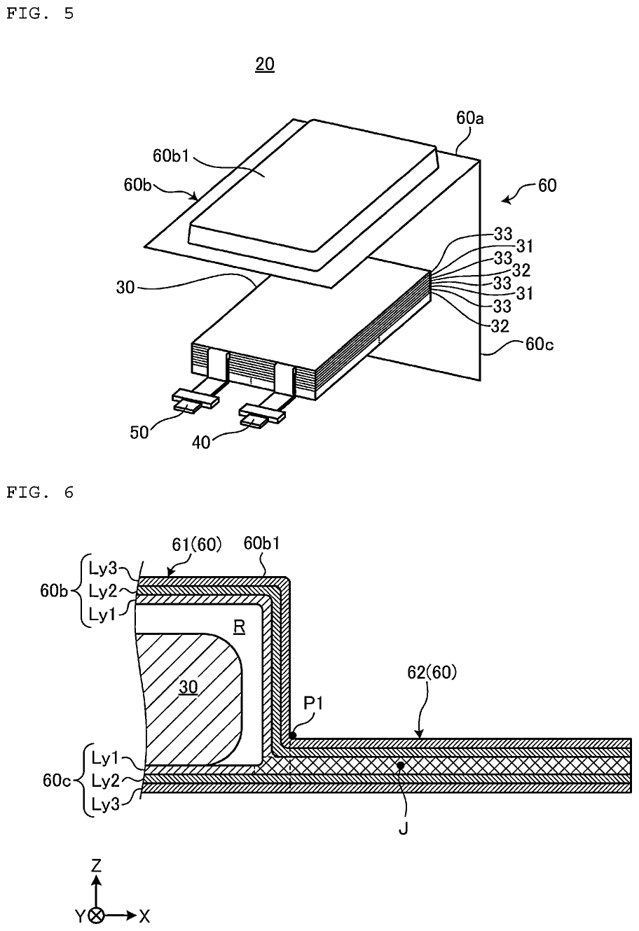

FIG. 3 is a plan view of the secondary battery. FIG. 4 is a side view of the secondary battery. The secondary battery 20 includes a laminated body 30, a positive electrode terminal 40, a negative electrode terminal 50, and an exterior body 60.

The laminated body 30 is a laminated type, and has a plurality of sheet-like positive electrodes 31 and negative electrodes 32, and the positive electrodes 31 and the negative electrodes 32 are alternately laminated with separators 33 interposed therebetween (see FIG. 5 described later).

The positive electrode terminal 40 is electrically connected to the positive electrode 31. A part of the positive electrode terminal 40 is located outside the exterior body 60. The negative electrode terminal 50 is electrically connected to the negative electrode 32. A part of the negative electrode terminal 50 is located outside the exterior body 60. The positive electrode terminal 40 and the negative electrode terminal 50 are electrically connected to an external connection terminal.

The exterior body 60 has a rectangular shape in plan view, and includes an accommodating portion 61 and a flange portion 62. The accommodating portion 61 accommodates the laminated body 30. In addition, the accommodating portion 61 stores an electrolyte (for example, a nonaqueous electrolytic solution).

The flange portion 62 is located around the accommodating portion 61 and is bendable (details will be described later). The flange portion 62 has a first portion 62a extending along a first direction D1 from the accommodating portion 61 toward the first inner surface 11d1, and a second portion 62b continuing from a distal end of the first portion 62a. The first direction D1 is parallel to the X direction and is a direction from the −X side to the +X side.

The second portion 62b has a first fixing surface 62b1 facing the first inner surface 11d1 and fixed to the first inner surface 11d1, and a first facing surface 62b2 on a side opposite to the first fixing surface 62b1 and faces the accommodating portion 61. In the laminating direction (Z direction) of the secondary batteries 20, a length L1 of the accommodating portion 61 is longer than a length L2 of the second portion 62b (see FIG. 4).

In addition, the flange portion 62 has a third portion 62c extending along a second direction D2 from the accommodating portion 61 toward the second inner surface 11e1, and a fourth portion 62d continuing from a distal end of the third portion 62c. The second direction D2 is parallel to the X direction and is a direction from the +X side to the −X side.

The fourth portion 62d has a second fixing surface 62d1 facing the second inner surface 11e1 and fixed to the second inner surface 11e1, and a second facing surface 62d2 on a side opposite to the second fixing surface 62d1 and facing the accommodating portion 61. In the laminating direction (Z direction) of the secondary batteries 20, the length L1 of the accommodating portion 61 is longer than a length L3 of the fourth portion 62d (see FIG. 4).

In this manner, the second portion 62b and the fourth portion 62d are located on sides opposite to each other across the accommodating portion 61. The second portion 62b and the fourth portion 62d are each formed by bending the flange portion 62 (details will be described later). As described above, the length L1 of the accommodating portion 61 is longer than the length L2 of the second portion 62b and the length L3 of the fourth portion 62d. Therefore, in the housing 10, in the plurality of secondary batteries 20, the second portions 62b and the fourth portions 62d of the two secondary batteries 20 adjacent to each other in the laminating direction do not interfere with each other, and the accommodating portions 61 of the two secondary batteries 20 adjacent to each other in the laminating direction are in contact with each other. Therefore, the volume of the housing 10 can be reduced.

Therefore, it is possible to reduce the size of the battery pack 1 and improve the volume energy density of the battery pack 1. The positive electrode terminal 40 and the negative electrode terminal 50 are disposed at portions of the flange portion 62 where the second portion 62b and the fourth portion 62d are not formed.

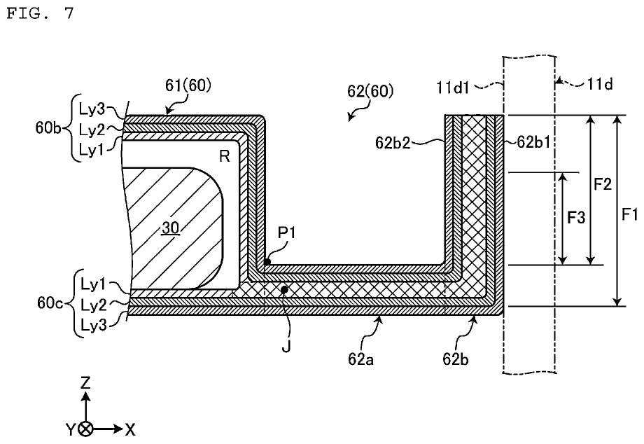

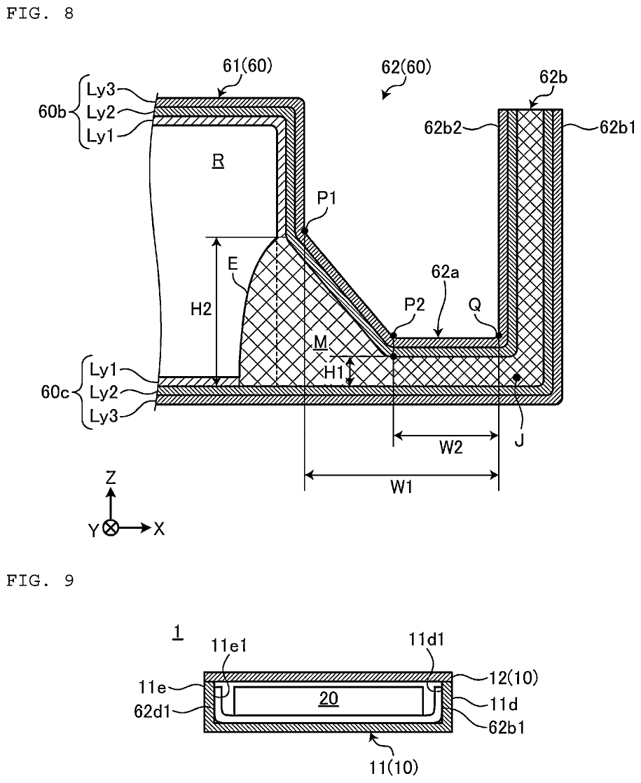

FIG. 5 is an exploded perspective view of the secondary battery. FIG. 6 is a sectional view taken along line A-A of the secondary battery before the second portion is formed. FIG. 7 is a sectional view taken along line A-A of the secondary battery shown in FIG. 3. Line A-A is a view showing a plane along the thickness direction (Z direction) of the flange portion 62. That is, FIGS. 6 and 7 show a cross-sectional shape of the secondary battery 20 when cut along a plane along the thickness direction of the flange portion 62.

As shown in FIG. 5, the exterior body 60 is formed by folding one film having a laminated structure (details will be described later) in which a metal layer Ly2 is sandwiched between a protective layer Ly3 and a resin layer Ly1 at a folded portion 60a such that the resin layer Ly1 is disposed on the inner side. The exterior body 60 includes a first exterior portion 60b and a second exterior portion 60c which are folded back at the folded portion 60a and overlap each other. The first exterior portion 60b and the second exterior portion 60c are continuous with the folded portion 60a interposed therebetween.

The first exterior portion 60b includes a protrusion 60b1. As shown in FIG. 6, the protrusion 60b1 has an accommodating space R for accommodating the laminated body 30 on the inner side. The accommodating space R has a size capable of accommodating the entire laminated body 30. The protrusion 60b1 is formed by, for example, pressing a central portion of the first exterior portion 60b in plan view.

The second exterior portion 60c has a flat plate shape which covers the accommodating space R and to which a portion around the convex portion 60b1 in the first exterior portion 60b is joined. That is, the accommodating portion 61 is formed of the convex portion 60b1 of the first exterior portion 60b and a portion of the second exterior portion 60c overlapping the convex portion 60b1 in plan view. In addition, the flange portion 62 is formed of a portion around the convex portion 60b1 in the first exterior portion 60b and a portion of the second exterior portion 60c overlapping the portion around the convex portion 60b1 in plan view.

The first exterior portion 60b and the second exterior portion 60c are joined at a portion other than the folded portion 60a around the convex portion 60b1. Specifically, the peripheral edge portion of the first exterior portion 60b and the peripheral edge portion of the second exterior portion 60c are joined to each other on each of three sides other than one side on which the folded portion 60a shown in FIG. 3 is formed. As a result, the first exterior portion 60b and the second exterior portion 60c are sealed, and leakage of the electrolyte is prevented.

The exterior body 60 may be formed of two films. In this case, one of the two films is the first exterior portion 60b, and the other is the second exterior portion 60c. In this case, the exterior body 60 does not have the folded portion 60a, and the peripheral edge portion of the first exterior portion 60b and the peripheral edge portion of the second exterior portion 60c are joined to each other over the entire periphery of the protrusion 60bl.

As shown in FIG. 6, each of the first exterior portion 60b and the second exterior portion 60c has a laminated structure including the resin layer Ly1. Specifically, in each of the first exterior portion 60b and the second exterior portion 60c, the resin layer Ly1, the metal layer Ly2, and the protective layer Ly3 are laminated in this order.

The resin layer Ly1 is formed of a thermoplastic resin such as polypropylene. The metal layer Ly2 is a layer that prevents permeation of gas, and is formed of, for example, an aluminum foil. The protective layer Ly3 is a layer that protects the exterior body 60, and is formed of, for example, a resin such as nylon and polyethylene terephthalate.

The exterior body 60 is folded back such that the resin layer Ly1 of the first exterior portion 60b and the resin layer Ly1 of the second exterior portion 60c face each other. By joining the resin layer Ly1 of the first exterior portion 60b and the resin layer Ly1 of the second exterior portion 60c, a joining portion J where the first exterior portion 60b and the second exterior portion 60c are joined is formed. The thickness of the joining portion J is substantially constant.

The joining portion J is formed by thermally welding the resin layer Ly1 of the first exterior portion 60b and the resin layer Ly1 of the second exterior portion 60c. Specifically, the exterior body 60 is folded back such that the resin layer Ly1 of the first exterior portion 60b and the resin layer Ly1 of the second exterior portion 60c face each other, and the first exterior portion 60b and the second exterior portion 60c are sandwiched and pressurized by a pair of heating members heated in advance from the peripheral edge (point P1) of the convex portion 60b1 to the peripheral edge of the exterior body 60 in a state where the first exterior portion 60b and the second exterior portion 60c overlap each other around the convex portion 60bl.

As a result, the resin layer Ly1 of the first exterior portion 60b and the resin layer Ly1 of the second exterior portion 60c are welded, and the joining portion J and furthermore, the flange portion 62 are formed. Thereafter, as shown in FIG. 7, the flange portion 62 is bent to form the first portion 62a and the second portion 62b. Specifically, the flange portion 62 is bent in a direction in which the second portion 62b has the first facing surface 62b2 (a direction in which the tip of the second portion 62b faces the +Z side). Similarly, the flange portion 62 is bent to form the third portion 62c and the fourth portion 62d having the second facing surface 62d2.

Next, attachment of the secondary battery 20 to the housing 10 will be described. As shown in FIG. 2, the flange portion 62 is fixed to the first inner surface 11d1 and the second inner surface 11e1, whereby the secondary battery 20 is attached to the housing 10. Specifically, the first fixing surface 62b1 of the second portion 62b is fixed to the first inner surface 11d1 using an adhesive or the like.

The entire first fixing surface 62b1 may be fixed to the first inner surface 11d1 in the Z direction as in a fixing range F1 shown in FIG. 7, or a portion other than the −Z-side end of the first fixing surface 62b1 in the Z direction may be fixed to the first inner surface 11d1 as in fixing ranges F2 and F3. Specifically, the fixing range F2 is a range from the distal end of the second portion 62b to the central portion of the first fixing surface 62b1 in the Z direction. The fixing range F3 is a range of a center portion of the first fixing surface 62b1 in the Z direction.

In addition, along the Y direction, the entire first fixing surface 62b1 may be fixed to the first inner surface 11d1, or a part of the first fixing surface 62b1 may be fixed to the first inner surface 11d1.

Similarly to the first fixing surface 62b1, the second fixing surface 62d1 of the fourth portion 62d is fixed to the second inner surface 11e1 using an adhesive or the like.

A portion of the secondary battery 20 other than the first fixing surface 62b1 and the second fixing surface 62d1 is not fixed to the housing 10. For example, portions other than the accommodating portion 61 of the secondary battery 20 and the first fixing surface 62b1 and the second fixing surface 62d1 of the flange portion 62 are not fixed to the bottom wall 11b, the side wall 11c, and the lid portion 12.

The portion of the flange portion 62 that is not fixed to the first inner surface 11d1 and the second inner surface 11e1 is bendable. Specifically, the flange portion 62 is bent (deformed) to move in a direction in which the accommodating portion 61 approaches the first inner surface 11d1 or in a direction in which the accommodating portion 61 separates from the first inner surface 11d1. In addition, the flange portion 62 is bent to move in a direction in which the accommodating portion 61 approaches the second inner surface 11e1 or in a direction in which the accommodating portion 61 separates from the second inner surface 11e1. Furthermore, the flange portion 62 is bent such that the accommodating portion 61 moves along the laminating direction (Z direction).

That is, the accommodating portion 61 is relatively movable with respect to the first inner surface 11d1 and the second inner surface 11e1, and furthermore, the housing 10. The first exterior portion 60b and the second exterior portion 60c constituting the accommodating space R can also be bent (deformed). Further, the plurality of secondary batteries 20 may be fixed to each other by bonding surfaces (for example, the Z-direction-side surfaces of the accommodating portion 61) facing each other in the Z direction using an adhesive or the like.

In addition, the flange portion 62 is fixed to the housing 10 by the first fixing surface 62b1 and the second fixing surface 62d1 on both sides with the accommodating portion 61 interposed therebetween. Therefore, the fixing strength between the secondary battery 20 and the housing 10 can be secured.

Next, behavior in the battery pack 1 when the battery pack 1 vibrates due to vibration of the electric vehicle or the like when the battery pack 1 is attached to the electric vehicle or the like will be described.

When the battery pack 1 vibrates, the accommodating portion 61 of each secondary battery 20 tries to move to the upper, lower, left, right, front, and back in FIG. 2 in the housing 10. The accommodating portion 61 that tries to move is supported by the flange portion 62 and fixed to the housing 10. As described above, the flange portion 62 is bendable, and the stress generated when the accommodating portion 61 tries to move can be absorbed by the flange portion 62 of each secondary battery 20. Therefore, as compared with the case where each secondary battery 20 is fixed on the surface in the Z direction and the accommodating portion 61 of the lowermost secondary battery 20 is fixed to the housing 10, the stress generated in the exterior body 60 is not concentrated on the fixed portion of the lowermost secondary battery 20, and the stress is dispersed in each secondary battery 20. That is, it is possible to prevent the exterior body 60 from being damaged due to concentration of stress at a specific position of the exterior body 60.

Next, in a battery pack according to an embodiment, points different from an embodiment described above will be mainly described.

FIG. 8 is a sectional view taken along line A-A of the secondary battery in the battery pack according to an embodiment. A secondary battery 20 of an embodiment further includes a thick portion M.

The thick portion M is continuous with the joining portion J, faces the accommodating space R, and becomes thicker toward the accommodating space R. The thick portion M is formed when the resin layer Ly1 of the first exterior portion 60b and the resin layer Ly1 of the second exterior portion 60c are thermally welded. Specifically, by adjusting the position, heating temperature, and pressure of the heating members such that the thickness becomes about 75% of the value obtained by adding the thickness of the resin layer Ly1 of the first exterior portion 60b and the thickness of the resin layer Ly1 of the second exterior portion 60c, the molten resin moves to the accommodating space R side, and the thick portion M can be formed.

In an embodiment, the pair of heating members sandwich the first exterior portion 60b and the second exterior portion 60c from the peripheral edge (point P1) of the convex portion 60b1 to the peripheral edge of the exterior body 60. On the other hand, in an embodiment, the pair of heating members sandwich the first exterior portion 60b and the second exterior portion 60c from a position (point P2) away from the peripheral edge (point P1) of the convex portion 60b1 by a predetermined distance along the X direction to the peripheral edge of the exterior body 60.

As a result, the melted resin in the resin layer Ly1 of the first exterior portion 60b and the resin layer Ly1 of the second exterior portion 60c moves to the accommodating space R side, whereby the thick portion M is formed. The thick portion M is formed on the accommodating space R side with respect to the point P2 in the X direction. The thickness of the thick portion M can be adjusted by the position of the point P2, the temperature and the pressure of the pair of heating members, and the like.

The thick portion M suppresses stress generated when the battery pack 1 vibrates and the accommodating portion 61 tries to move. That is, the thick portion M is deformed so as to contract and extend with respect to the movement of the accommodating portion 61, whereby stress can be suppressed. The stress generated in the exterior body 60 can be further suppressed as compared with the case where the joining portion J does not have the thick portion M. Accordingly, it is possible to suppress breakage of the exterior body 60.

The secondary battery 20 of an embodiment further includes a protruding portion E. The protruding portion E is a part of the joining portion J, and protrudes from the joining portion J to the accommodating space R. In an embodiment, the protruding portion E is a part of the thick portion M and is a portion of the thick portion M protruding to the accommodating space R.

The protruding portion E is formed when the resin layer Ly1 of the first exterior portion 60b and the resin layer Ly1 of the second exterior portion 60c are thermally welded. Specifically, at the time of thermal welding, the resin melted in the resin layer Ly1 of the first exterior portion 60b and the resin layer Ly1 of the second exterior portion 60c protrudes into the accommodating space R, whereby the protruding portion E is formed. The protruding portion E is a so-called weld bead. The size of the protruding portion E can be adjusted by the position of the point P2, the temperature and the pressure of the pair of heating members, and the like. The protruding portion E may also be formed in the secondary battery 20 of an embodiment in which the thick portion M is not formed.

When the battery pack 1 vibrates, the thick portion M is more easily deformed due to the presence of the protruding portion E, and the stress generated in the exterior body 60 is further suppressed. That is, the stress generated in the exterior body 60 is further suppressed as compared with the case where the joining portion J does not have the protruding portion E. Accordingly, it is possible to suppress breakage of the exterior body 60.

Next, results of a drum test of the battery pack 1 will be described with reference to Table 1 and FIG. 8. The drum test is a test in which the battery pack 1 is housed in a drum having a predetermined inner diameter set in advance, and the drum is rotated around the axis to repeatedly drop the battery pack 1 in the drum, and the time until the exterior body 60 is damaged is checked.

Battery packs 1 according to 15 kinds of Examples shown in the column of “Example” in Table 1 were prepared, and the drum test was performed. The battery packs 1 according to the 15 kinds of Examples were formed in the same manner as in an embodiment or an embodiment except for the items shown in Table 1. The battery pack 1 includes 10 secondary batteries 20.

In Table 1, the column of “Second Portion/Fourth Portion” indicates the presence or absence of the second portion 62b and the fourth portion 62d, and the column of “Thick Portion” indicates the presence or absence of the thick portion M. In the secondary batteries 20 according to the 15 kinds of Examples, the protruding portion E is also formed when the thick portion M exists, and the protruding portion E is not formed when the thick portion M does not exist.

As shown in FIG. 8, the column of “W1” indicates the length in the X direction between the peripheral edge (point P1) of the accommodating portion 61 and the proximal end (point Q) of the second portion 62b (fourth portion 62d) in the flange portion 62. The column of “W2” indicates the length in the X direction between the end (point P2) of the thick portion M on the peripheral edge side of the flange portion 62 and the proximal end (point Q) of the second portion 62b (fourth portion 62d) in the flange portion 62.

The column of “H2/H1” indicates a thickness ratio of the thick portion M. H1 is a thickness (length in the Z direction) of the end of the thick portion M on the peripheral edge side of the flange portion 62, and H2 is a thickness (length in the Z direction) of the end of the thick portion M on the accommodating space R side. That is, as the value of H2/H1 is larger, the length of the thick portion M in the Z direction on the accommodating space R side is longer, and the thick portion M is thicker.

The column of “Case Width” indicates a length between the first inner surface 11d1 and the second inner surface 11e1. That is, it indicates a length (length in the X direction) between the first fixing surface 62b1 and the second fixing surface 62d1. The column of “Result” indicates a time from the start of the test until breakage of the exterior body 60 can be confirmed.

TABLE 1

| | | | | | | Case | |
|---|---|---|---|---|---|---|---|
| | Second Portion/ | Thick | W1 | W2 | | Width | Result |
| Example | Fourth Portion | Portion | (MM) | (mm) | H2/H1 | (mm) | (Hours) |
| 1 | Absent | Absent | — | — | — | 126 | 3 |
| 2 | Present | Absent | 3 | — | — | 120 | 4 |
| 3 | Present | Present | 3 | 0.5 | 1.2 | 120 | 5 |
| 4 | Present | Present | 3.5 | 1.0 | 1.2 | 121 | 6 |
| 5 | Present | Present | 4.0 | 1.5 | 1.2 | 122 | 7 |
| 6 | Present | Present | 4.5 | 2.0 | 1.2 | 123 | 8 |
| 7 | Present | Present | 5.0 | 2.5 | 1.2 | 124 | 6 |
| 8 | Present | Present | 5.5 | 3.0 | 1.2 | 125 | 3 |
| 9 | Present | Present | 3 | 0.5 | 1.5 | 120 | 4 |
| 10 | Present | Present | 3 | 0.5 | 2.0 | 120 | 5 |
| 11 | Present | Present | 3 | 0.5 | 3.0 | 120 | 6 |
| 12 | Present | Present | 3 | 0.5 | 4.0 | 120 | 7 |
| 13 | Present | Present | 3 | 0.5 | 5.0 | 120 | 8 |
| 14 | Present | Present | 3 | 0.5 | 6.0 | 120 | 3 |
| 15 | Present | Present | 3 | 0.5 | 7.0 | 120 | 2 |

The secondary battery 20 of Example 1 is a secondary battery 20 before the second portion 62b (fourth portion 62d) shown in FIG. 7 is formed without the second portion 62b, the fourth portion 62d, and the thick portion M. When there are no second portion 62b, fourth portion 62d, and thick portion M, “−” indicating that there is no value is stored in the fields of “W1”, “W2”, and “H2/H1”. Note that the length in the X direction between the peripheral edge (point P1) of the accommodating portion 61 and the end of the flange portion 62 is 6 mm, and the thickness of the joining portion J and furthermore, the thickness of the flange portion 62 are substantially constant.

In Example 1, the “Case Width” is “126” (mm). In Example 1, both ends in the X direction of the flange portion 62 are fixed to the first inner surface 11d1 and the second inner surface 11e1 using an adhesive or the like.

In Example 1, the “Result” is “3” (hours). In the secondary battery 20 formed in the same manner as in Example 1 as a comparative example, the drum test was also performed in the case where the accommodating portion 61 of the lowermost secondary battery 20 was fixed to the housing 10 by adhesion on the Z-direction surface of the accommodating portion 61 in the same manner as in the conventional technique. The result of the drum test was “0.5” (hours). The result of the comparative example is shorter than the result of Example 1 in which the accommodating portion 61 is not fixed to the housing 10.

Example 2 is different from Example 1 in that it includes the second portion 62b and the fourth portion 62d. The width (length in the X direction) of the secondary battery 20 is shorter than that in Example 1 by the amount of the second portion 62b and the fourth portion 62d, and the “Case Width” is shorter than that in Example 1. In Example 2, the “Result” is “4” (hours), which is longer than that in Example 1. This result indicates that the second portion 62b and the fourth portion 62d contribute to suppression of the magnitude of the stress of the exterior body 60.

Example 3 is different from Example 2 in that the thick portion M is provided. The length of the thick portion M in the X direction is about 2.5 (=3(W1)−0.5(W2)) mm. The value of “H2/H1” is 1.2. In Example 3, the “Result” is “5” (hours), which is longer than that in Example 2. This result indicates that the thick portion M contributes to the suppression of the impact acting on the exterior body 60.

In Examples 4, 5, 6, 7, and 8, the value of “W2” sequentially increases as compared with Example 3. As the value of “W2” changes, the values of “W1” and “Case Width” change. “Results” of Examples 4, 5, 6, 7, and 8 are the best in Example 6, and are “8” (hours). This result indicates that the length between the thick portion M and the second portion 62b (fourth portion 62d) has an appropriate length for suppressing the magnitude of the stress. That is, when the value of “W2” is relatively small, it is conceivable that the flange portion 62 is not sufficiently bent. On the other hand, when the value of “W2” is relatively large, it is conceivable that the exterior body 60 is repeatedly bent at the same portion and the exterior body 60 is damaged.

In Examples 9, 10, 11, 12, 13, 14, and 15, the value of “H2/H1” sequentially increases as compared with Example 3, and the thickness of the thick portion M on the accommodating space R side sequentially increases. “Results” of Examples 9, 10, 11, 12, 13, 14, and 15 are the best in Example 13, and are “8” (hours). This result indicates that the thickness of the thick portion M on the accommodating space R side has an appropriate thickness at which the thick portion M suppresses stress. That is, when the value of “H2/H1” is relatively small, it is considered that the thick portion M does not sufficiently suppress the stress due to the insufficient volume of the thick portion M. On the other hand, when the value of “H2/H1” is relatively large, it is considered that the thick portion M does not sufficiently suppress the stress because the thick portion M is hardly deformed.

Note that the embodiments described herein are intended to facilitate understanding of the present disclosure, but not intended to construe the present disclosure in any limited way. The present disclosure may be modified/improved without departing from the spirit thereof, and the present disclosure includes equivalents thereof.

For example, the secondary battery 20 may not have the fourth portion 62d. In this case, the flange portion 62 is bent at one place, and the second portion 62b is formed.

In addition, the second portion 62b and the fourth portion 62d may be formed by bending the flange portion 62 in a direction opposite to the embodiment described above (that is, a direction in which the distal ends of the second portion 62b and the fourth portion 62d face the −Z side). Furthermore, the lengths L2 and L3 of the second portion 62b and the fourth portion 62d shown in FIG. 4 may be equal to or longer than the length L1 of the accommodating portion 61.

FIG. 9 is a longitudinal sectional view of a battery pack according to a modification of an embodiment. The battery pack 1 of this modification includes one secondary battery 20. One secondary battery 20 is housed in the housing 10. In one secondary battery 20, the first fixing surface 62b1 is fixed to the first inner surface 11d1, and the second fixing surface 62d1 is fixed to the second inner surface 11el.

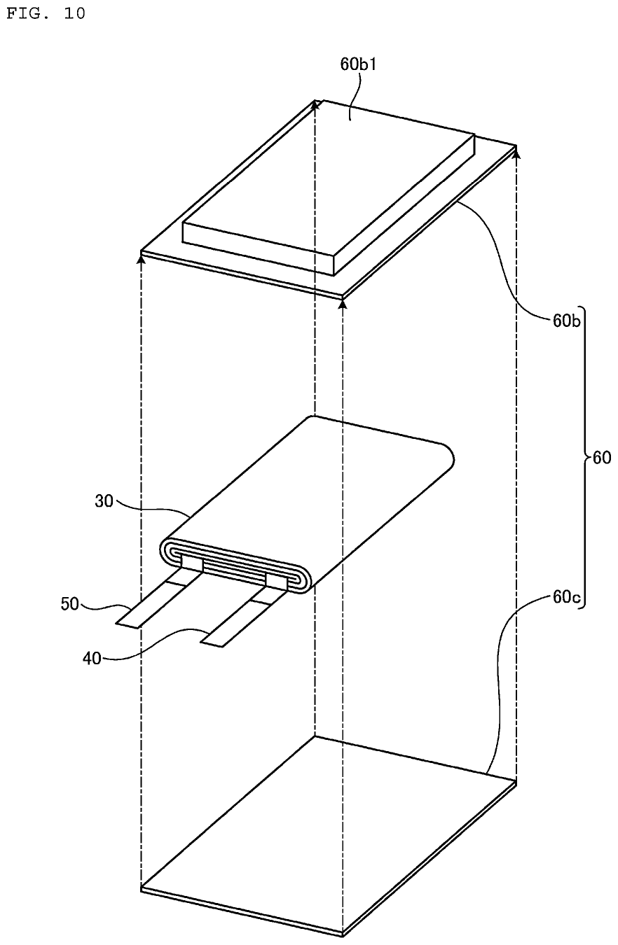

FIG. 10 is an exploded perspective view of a secondary battery according to another modification of an embodiment. As shown in FIG. 10, the laminated body 30 is a wound type, and the positive electrode 31 and the negative electrode 32 are alternately laminated with the separator 33 interposed therebetween and wound. The exterior body 60 shown in FIG. 10 is formed of two films. Note that the laminated body 30 may be composed of all solids. In this case, the laminated body 30 has a positive electrode and a negative electrode, and an electrolytic solution is stored in the accommodating space R.

Although the drum test described above was performed on the secondary battery 20 in which the laminated body 30 is a laminated type, the same result was obtained also in the secondary battery 20 in which the laminated body 30 shown in FIG. 10 is a wound type. In the drum test described above, although the battery pack 1 had 10 secondary batteries 20, the same result was obtained when the battery pack 1 had one secondary battery 20 (see FIG. 9).

In addition, the secondary battery 20 may have a shape other than the rectangular shape in plan view, for example, may have a circular shape in plan view. In this case, the joining portion J may have a circular shape in plan view.

Further, a part of the accommodating portion 61 of the secondary battery 20 may be fixed to the inner surface of the housing 10. In this case, as the portion where the accommodating portion 61 is fixed to the housing 10 and the flange portion 62 are separated from each other, the flange portion 62 is easily bent, and the magnitude of the stress generated in the exterior body 60 is suppressed.

DESCRIPTION OF REFERENCE SYMBOLS
1: Battery pack
10: Housing
11d1: First inner surface
11e1: Second inner surface
20: Secondary battery
30: Laminated body
31: Positive electrode
32: Negative electrode
33: Separator
60: Exterior body
60b: First exterior portion
60c: Second exterior portion
61: Accommodating portion
62: Flange portion
62a: First portion
62b: Second portion
62c: Third portion
62d: Fourth portion
62b1: First fixing surface
62d1: Second fixing surface
62b2: First facing surface (facing surface)
D1: First direction
D2: Second direction
E: Protruding portion
J: Joining portion
Ly1: Resin layer
R: Accommodating space
M: Thick portion

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a secondary battery including a laminated body including a plurality of positive electrodes and a plurality of negative electrodes, the positive electrodes and the negative electrodes being alternately laminated with separators interposed therebetween, and an exterior body; and
a housing that accommodates the secondary battery,
wherein the exterior body includes an accommodating portion that accommodates the laminated body, and a flange portion that is bendable around the accommodating portion,
the housing has a first inner surface and a second inner surface facing the first inner surface with the accommodating portion interposed therebetween,
the flange portion includes:
a first portion extending along a first direction from the accommodating portion toward the first inner surface;
a second portion that is continuous from a distal end of the first portion and has a first fixing surface fixed to the first inner surface;
a third portion extending along a second direction from the accommodating portion toward the second inner surface; and
a fourth portion that is continuous from a distal end of the third portion and has a second fixing surface fixed to the second inner surface, and
in the flange portion, a portion along the first direction between the accommodating portion and the first fixing surface and a portion along the second direction between the accommodating portion and the second fixing surface are bendable in a direction in which the accommodating portion approaches the first inner surface or in a direction in which the accommodating portion separates from the first inner surface.

2. The battery pack according to claim 1, wherein the second portion has a facing surface that is on a side opposite to the first fixing surface and faces the accommodating portion.

3. The battery pack according to claim 2, further comprising a plurality of the secondary batteries,
wherein the plurality of the secondary batteries are laminated in a state where the accommodating portions overlap each other, and
a length of the accommodating portion is longer than a length of the second portion in a laminating direction of the secondary batteries.

4. The battery pack according to claim 1, wherein
the exterior body includes a first exterior portion and a second exterior portion each having a laminated structure including a resin layer,
the accommodating portion has an accommodating space in which the laminated body is located between the first exterior portion and the second exterior portion,
the flange portion includes a joining portion where the resin layer of the first exterior portion and the resin layer of the second exterior portion are joined, and
the joining portion includes a thick portion facing the accommodating space and increasing in thickness toward the accommodating space.

5. The battery pack according to claim 4, wherein the joining portion further includes a protruding portion in which a resin protrudes toward the accommodating space.

6. The battery pack according to claim 1, wherein
the housing accommodates a plurality of the secondary batteries, and
the plurality of the secondary batteries are laminated in a thickness direction.
